(19) United States
(12) Patent Application Publication
(10) Pub. No.: US 2005/0240993 A1
(43) Pub. Date: Oct. 27, 2005

(54) Methodology, system and computer readable medium for streams-based packet filtering

(76) Inventors: William S. Treadwell, Alexandria, VA (US); Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/830,978

(22) Filed: Apr. 22, 2004

(51) Int. Cl. H04L 9/00

(52) U.S. Cl. 726/13

(57) ABSTRACT

A packet filtering system for use with a host computer implementing a streams sub-system comprises a configuration component for maintaining a collection of configuration parameters based on user input, and a streams interface component for managing bi-directional transmission of packets according to the collection of configuration parameters. The configuration parameters may include sets of authorized port, protocol and address designations. The streams interface component preferably includes corresponding modules for port filtering, protocol filtering and address filtering whereby inbound and outbound packets which are not blocked by any of filtering modules are, respectively, passed upstream and downstream between an associated network device and the stream head. A computerized method for managing bi-directional transmission of packets, as well as a computer-readable medium having executable instructions for managing packet transmission, are also provided.

### BACKGROUND OF THE INVENTION

The present invention broadly relates to the field of computer system security. The present invention more particularly concerns firewall implementations at the kernel processing level of a computer system, such as a networked computer configured with a UNIX System V operating system implementing a STREAMS sub-system.

The term “firewall” generically refers to security policy implementations designed to secure a system from intruders. A firewall may separate a protected network from an unprotected network and, in many cases, one protected area of a network from another area on the same network. For example, if a company's employees have access to the Internet, the actual Internet connection can be made through a firewall, such as a bastion host, to protect the network against external intrusion. Similarly, internal firewalls can be used insulate internal network resources, such as a company's sensitive or confidential information, so that they are only accessible on a “need-to-know” basis and are not vulnerable to snooping from within the enterprise. Firewalls installed to protect entire networks are typically implemented in hardware, while software firewalls are also available to protect individual workstations from attack.

Firewalls can be generalized into two categories—traditional network level firewalls and personal firewalls. Network level firewalls sit at a choke point on the network and allow traffic through or block traffic based on parameters known as rules. A network level firewall may comprise a screening router or special-purpose computer that filters out unwanted packets, or a combination of routers and servers each performing some type of firewall processing. Network level firewalls can reside on a dedicated piece of hardware or a variety of operating systems such as Solaris, Linux, Windows and Mac OS X, to name a representative few.

Packet filtering can be used to block traffic based on a specific IP address or application type. Many of the modern packet filtering systems, such as iptables, contain features such as connection tracking for verifying transition of packets from source and destination. Connection tracking more particularly refers to the ability to maintain state information about a connection in memory tables, such as source and destination ip address and port number pairs (i.e. socket pairs), protocol types, connection state and timeouts. Firewalls that provide this are known as stateful and are inherently more secure that simple packet filtering. Almost all modern packet filtering systems additionally allow for the proxy of special types of traffic such as the file transfer protocol (FTP), Internet relay chat, and many modern Internet music stations (RealPlayer, Media Player, etc.). The filtering is based on the mechanisms set forth for each individual situation, such as Web traffic requests allowed outbound, but not inbound, etc.

Predominantly, personal firewalls reside at layers 2 and 3 of the TCP/IP protocol stack (layers 3 & 4, respectively, of the OSI model), thereby intercepting network communications only. Unfortunately, if a hostile piece of software is loaded onto a local machine, the personal firewall is of minimal use because it is only designed to protect against network based attacks and not local based attacks. Additionally, most personal firewalls reside solely on personal desktop-based systems. Examples of these include “Zone Alarm” available from Zone Labs® of San Francisco, Calif.; “Black Ice” available from Internet Security Systems® of Atlanta, Ga.; and “Norton's Personal Firewall” available from Symantec® of Cupertino, Calif. Each of these programs basically provides security from people being able to connect to a machine without the owner's knowledge. They focus on protecting against attacks coming in along the wire, but do not address software vulnerabilities. There are no firewalls known to the inventors which reside, for example, on out-of-the-box implementation of the UNIX OS, such as the Solaris OS. Solaris (formerly SunOS) is a well-known multitasking, multi-processing operating system and distributed computing environment for Sun's SPARC computer from SunSoft. Solaris usually refers, collectively, to the SunOS UNIX SVR4-based operating system and its accompanying software bundle including, among other things, ONC networking products (NFS, NIS, etc.) and OpenWindows (Sun's version of X Windows).

Since many implementations of firewalls protect machines on a per packet basis or from network attacks, to date, firewalls do not go the extra distance to protect the network sub-system of the machine it is running on. This is the case, for example, with the STREAMS-based architecture which is a feature of UNIX System V in general, and the Solaris implementation in particular. The STREAMS sub-system provides a framework for data transfer among UNIX system services, including network communications and their terminal sub-system. More particularly, STREAMS provides a standardization for dynamically building and passing messages up and down a protocol stack such as TCP/IP. STREAMS represent a collection of the system calls, kernel resources and kernel utility routines for creating, using and dismantling a stream. STREAMS provide a full-duplex connection between a process in user space and a driver in kernel space. In this context the driver can be either a hardware driver or a pseudo-device driver (e.g., a software driver).

STREAMS has its origin in the Unix OS. Originally developed in the early 1980s at Bell Labs in an effort to provide a standard common facility for communications device drivers and protocols, STREAMS was initially released as part of AT&T SVR3 (System Five, release 3) Unix in the mid 1980's. It was augmented with several new features as part of SVR4 (release 4) and has been available as a feature in at least one real-time OS, LynxOS, since about 1993. STREAMS provides full-duplex data paths between device drivers and applications. It utilizes message prioritization and provides a mechanism to layer or “push” modules on top of each other at runtime. This is quite useful for implementation of network protocols that have a layered architecture, such as those following the OSI model. STREAMS also supports multiplexing, which is also a common requirement of communication protocols. A single networking protocol can, thus, use the STREAMS multiplexing feature to run simultaneously on two different physical layers, for example.

Prior art FIG. 1 diagrammatically illustrates the infrastructure of a simplified STREAMS sub-system interface. The STREAMS sub-system architecture is well understood and informative resources which describe it, as well as UNIX network programming in general, include Rago, S.A. “UNIX System V Network Programming”, Addison-Wesley, Reading, Mass. (1993) and AT&T, “Unix System V Release 3.2 STREAMS Programmer's Guide”, Englewood Cliffs, N.J., Prentice Hall (1989), among others. Accordingly, FIG. 1 is provided for illustrative purposes only. In FIG. 1, Stream 100 passes data in the form of messages between the stream head 110 and a driver 112. The stream head 110 determines whether the data transfer is network based (IP, ARP, etc.), or terminal based (i.e. TTY). Regardless of the origin, the inner sub-system communication mechanism remains the same. An application process 114 that requires the STREAMS sub-system 100 makes a system call from user space.

Messages are the only means of transferring data and communicating within a stream. Once the communication has ceased, the stream head 110 is torn down and the memory that was allocated from the stream is freed for later use by the kernel. A STREAMS message contains data, status or control information, or a combination of both. Each message includes a specified message type indicator and identifies its contents. Data sent to the driver from a user process is packaged into STREAMS messages for transmission. Messages that are passed from the stream head 110 toward the driver 112 are said to travel downstream while those messages passed in the reverse direction travel upstream. Downstream messages arriving at stream head 110 are copied from user buffers and processed by the stream head.

A process can dynamically add or remove intermediate processing modules between the stream head 110 and driver 112. In FIG. 1, a set of processing modules 116 is depicted for illustration, with it being understood that each module performs intermediate transformations of messages passing between the stream head 110 and the driver 112. As well known, each module is constructed from a pair of QUEUE structures in order to implement the bidirectional and symmetrical attributes of the Stream. Each QUEUE in a module can contain one or more messages which are dynamically attached to the QUEUE on a linked list (message queue) as well as processing procedures.

As stated above out-of-the-box implementations of the UNIX OS, such as the Solaris OS, do not provide for firewall protection for the network sub-system; as such, they can be particularly vulnerable to local based attacks implemented at the kernel level. For example, an intruder could surreptitiously hack into a UNIX-based networked computer, or other type, via an external attack and install a rootkit for the purpose of originating communications to the intruder's off-site machine. Alternatively, the attack could originate internally. That is, for example, even if a network level firewall might prevent infiltration of the local machine from the outside, a rootkit could nonetheless be installed by one having direct access to the local machine, such as a rogue administrator. Current personal firewalls do not address this because they assume that communications initiated by the local machine (i.e. the machine the firewall resides on) are authorized.

Accordingly, there remains a need to provide a new and improved approach to protecting the network sub-system of a machine from external attacks, such as the STREAMS infrastructure within the Unix System V kernel. It is also desirable to further secure the computer itself from internal attacks in a manner which utilizes features found within the STREAMS sub-system. The present invention is primarily directed to meeting these needs.

### BRIEF SUMMARY OF THE INVENTION

It is an object of the present invention to provide a new and improved packet filtering system for regulating the transmission of inbound and outbound packets in a STREAMS sub-system, as well as a computerized method and computer-readable medium for accomplishing the same.

Another object of the present invention is to provide such a system, method and computer-readable medium which can be customized to an administrators' security preferences.

A further object of the present invention is to provide such a system, method and computer-readable medium which provides additional security by effectively concealing these preferences until runtime.

Yet another object of the present invention is to provide such as system, method and computer-readable medium which can be readily implemented within a existing Unix System V OS environment, such as Solaris.

In accordance with these objectives, the present invention provides a packet filtering system, a computerized methodology and a computer readable medium, each for use with a host computer. The host computer may be configured with a UNIX System V operating system (OS), such as Solaris, which implements a STREAMS subsystem that invokes a stream head for regulating data transfer between user processes and drivers.

One embodiment of the packet filtering system of the invention comprises a configuration component for maintaining a collection of configuration parameters based on user input, and a STREAMS interface component for managing bi-directional transmission of packets according to the configuration parameters. The configuration parameters may include a set of authorized port designations, a set of authorized protocol designations, and a set of authorized address designations. The authorized port designations identify trusted source ports on the host computer for originating outbound network traffic and trusted listening ports for receiving inbound network traffic. The authorized protocol designations identify trusted communications protocols for inbound and outbound network traffic, respectively. The authorized address designations identify trusted source addresses for inbound network traffic and trusted destination addresses for outbound network traffic.

The STREAMS interface component includes corresponding filtering modules which can be dynamically inserted into the stream at runtime. A port filtering module is dynamically insertable into the stream between the stream head and the driver and operates to analyze inbound and outbound packets to block transmission of packets which do not conform to the set of authorized port designations. A protocol filtering module is dynamically insertable into the stream, upstream of the port filtering module, and it operates to analyze inbound and outbound packets and to block transmission of those which do not conform to the set of authorized protocol designations. The protocol filtering module can also regulate packet transmission based on whether the packets are RFC compliant. Similarly, an address filtering module is dynamically insertable upstream of the protocol filtering module for analyzing inbound and outbound packets, and for blocking transmission of those which do not conform to the set of authorized address designations. Address filtering can work in conjunction with connection tracking to ensure that only packets with valid state information are transmitted. As such, inbound and outbound packets which are not blocked by any of the filtering modules are passed upstream and downstream between an associated device and stream head.

A collection of configuration parameters are preferably input into the configuration component via a user interface. It is also preferred that the collection of configuration parameters identify a set of authorized modules for implementation within the STREAMS subsystem. Preferably, the port filtering module, the protocol filtering module and the connection tracking and address filtering module are within this set. It is preferred that the packet filtering system include encryption/decryption engines so that the collection of configuration parameters can be stored in an enciphered format when not needed, yet decrypted and made available to the configuration console at runtime. The STREAMS interface component operates to monitor the collection of configuration parameters within the configuration component and only permits authorized modules to be dynamically loaded into the stream at runtime.

Another advantageous embodiment of the packet filtering system of the invention comprises a storage device and a processor. The storage device stores a configuration file that includes the collection of inbound and outbound configuration parameters. The processor is programmed, with respect to inbound packets intended for transmission via the STREAMS subsystem from an associated network driver to an associated user process, to pass each of the inbound packets to an upstream filter that is functionally interfaced between the associated network driver and the stream head. The filter permits upstream transmission to the stream head of inbound packets which conform to the inbound configuration parameters, while blocking transmission to the stream head of inbound packets which fail to conform to the inbound configuration parameters. The processor is additionally programmed, with respect to outbound packets intended for downstream transmission in the STREAMS subsystem from an associated user process to an associated network driver, to pass each of the outbound packets to a downstream filter that is functionally interfaced between the stream head and network driver. This downstream filter permits downstream transmission to the associated network driver of outbound packets which conform to the outbound configuration parameters, while blocking downstream transmission to the associated network driver of outbound packets which fail to conform the outbound configuration parameters.

The present invention also advantageously provides a computerized method for the bi-directional management of packet transmission, which method preferably entails these same processing operations and other aspects discussed above with respect to the packet filtering system. In addition, the computerized method preferably ensures that each of the protocols within the set of authorized protocol designations is RFC compliant, and stores the enciphered configuration file in non-volatile memory on the host computer. Finally, a computer-readable medium is provided having executable instructions for managing transmission of packets within the STREAMS subsystem according to the methodology described herein.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 diagrammatically illustrates the infrastructure of a typical, and simplified, STREAMS sub-system according to the prior art;

FIG. 2 illustrates a diagram of an exemplary host computer that may be used in implementing packet filtering aspects described herein, thus forming one exemplary embodiment of a packet filtering system;

FIG. 3 is a functional block diagram of a Unix System V kernel associated with a computer system implementing the packet filtering aspects of the present invention, and particularly illustrating the functional role of the STREAMS Security Executive (SSE) therein;

FIG. 4 is a diagrammatic view illustrating the principle components of the packet filtering system of the present invention;

FIG. 5 is a block diagram showing the principle features of the STREAMS interface component of the invention;

FIG. 6 is a high level flow diagram illustrating one representative approach for initializing the packet filtering system of the present invention;

FIG. 7 is a diagrammatic view illustrating a TCP/IP implementation of the STREAMS sub-system interface of the present invention as it functions to manage the transmission of packets up and down the protocol stack; and

FIG. 8 is a high level flow diagram for computer software which implements the functions of the packet filtering system of the present invention.

### DETAILED DESCRIPTION OF THE INVENTION

The present invention addresses the drawbacks discussed above with respect to known packet filtering systems by providing a computerized method, computer readable medium and a system for protecting a computer system from both internal and external threats. In exemplary embodiments this is accomplished by regulating inbound and outbound packet transmissions in a UNIX System V OS, such as Solaris, which implements a STREAMS sub-system. A detailed explanation of Unix System V and its associated STREAMS infrastructure (including such aspects as structures and declarations for STREAMS messages, queue data, multiplexing modules, etc.) is beyond the scope of this document and the reader is assumed to be either conversant with its kernel architecture or to have access to conventional literature on the subject.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer networking and operating systems in general, and the Unix System V OS in particular. While the description to follow may entail terminology which is perhaps tailored to certain environments, the ordinarily skilled artisan will appreciate that such terminology is employed in a descriptive sense and not a limiting sense. Where a confined meaning of a term is intended, it will be explicitly set forth or otherwise apparent from the disclosure.

Aspects of the present invention may be implemented on a user's/client computer 200, such as shown in FIG. 2. More particularly, the general purpose computer 200 may be used to execute applications comprising computerized packet filtering systems constructed in accordance with the present invention, and is adapted to execute in a Unix System V OS environment, such as the Solaris 9 OS, which implements STREAMS. In its preferred form, the present invention is implemented on a host computer 200 which resides as a node on a network architecture and functions as either a server or a client machine.

Computer system 200 comprises a central processing unit (CPU) 210, a memory 220 and an I/O system 230. The memory may include volatile memory such as static or dynamic RAM and non-volatile memory such as ROMs, PROMs, EPROMs. Various types of storage devices 240 can be provided as more permanent storage areas. These devices may be a permanent storage device such as a large-capacity hard disk drive, or a removable storage device such as a floppy disk drive, a CD-ROM drive, a DVD-ROM drive, flash memory, a magnetic tape medium, or the like. Remote storage over a network is also contemplated. One or more of the memory or storage regions may contain programming code capable of configuring the computer system 200 to embody aspects of the present invention. The present invention, thus, encompasses program storage on an appropriate computer-readable medium, such as RAM, ROM, a disk drive, or the like and which is executable by processor 210, thereby to form one exemplary packet filtering system of the invention. The I/O system 230 may operate with various input and output devices, 250 & 260 respectively, such as a keyboard, a display, a pointing device. It may also operate with a data network 270 via a suitable communications link 280.

The source code for the software could be developed in C on an x86 or SPARC machine running the Unix System V operating system (OS). It is believed, however, that suitable programming could also be developed using several widely available programming languages with the software component(s) coded as sub-routines, sub-systems, or objects depending on the language chosen. In addition, various low-level languages or assembly languages could be used to provide the syntax for organizing the programming instructions so that they are executable in accordance with the description to follow. It is, moreover, contemplated that the features of the present invention could be ported to operating systems other than those implementing STREAMS.

Software embodying the present invention may be distributed in known manners, such as on computer-readable medium which contains the executable instructions for performing the methodologies discussed herein. Such software could be distributed as part of original OS installation media, or as a separated loadable kernel module distributed over an appropriate communications interface as part of a service pack modification to an original installation, to name a few possibilities. Furthermore, alternate embodiments which implement the invention in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

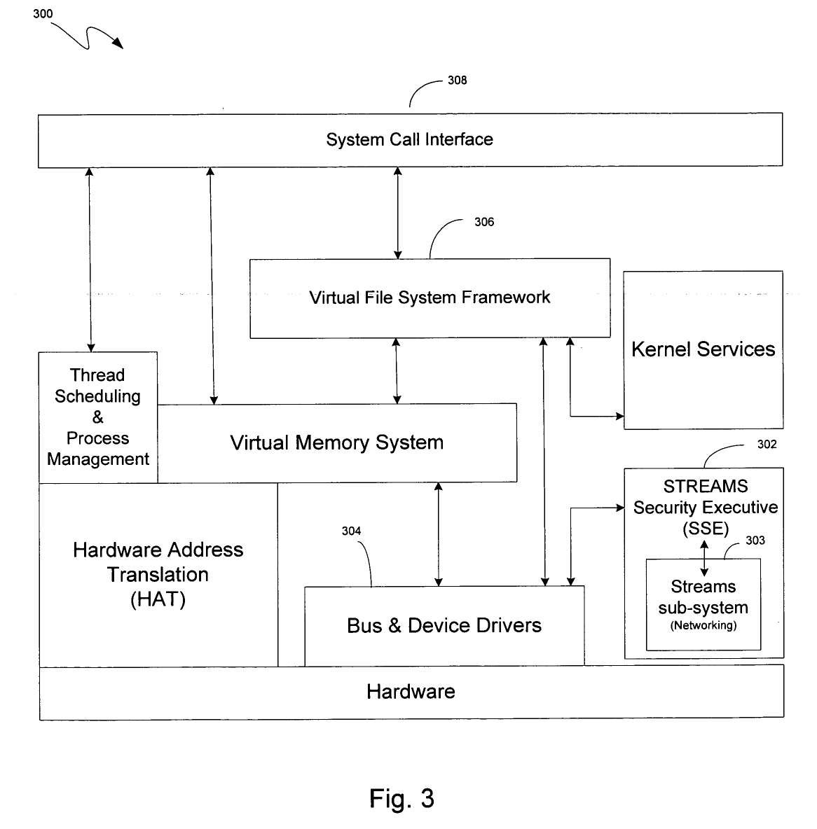

By way of further introduction, reference is now made to FIG. 3 which shows a functional block diagram of a UNIX System V OS 300 incorporating a STREAMS security executive (SSE) 302 according to the present invention. With the exception of the SSE 302, the functional components as diagrammatically illustrated in FIG. 3 are typical of the UNIX System V kernel, and thus need not be described in detail. FIG. 3 is, thus, provided to illustrate the functional interaction (i.e. interfacing) of the SSE component of the invention within this conventional OS infrastructure 300. SSE 302 functions as a wrapper around the existing STREAMS sub-system and manages the full-duplex processing of data transfer between drivers in kernel space and processes in user space. SSE 302 particularly manages the networking functions of the operating system based on guidelines established by an administrator or other person with root level access. Any modules that are to be loaded into the STREAMS sub-system 303 must get approval from the SSE. SSE 302 interacts directly with bus and device drivers 304, and additionally interfaces with user processes via the kernel's virtual file system framework 306 and a system call interface 308.

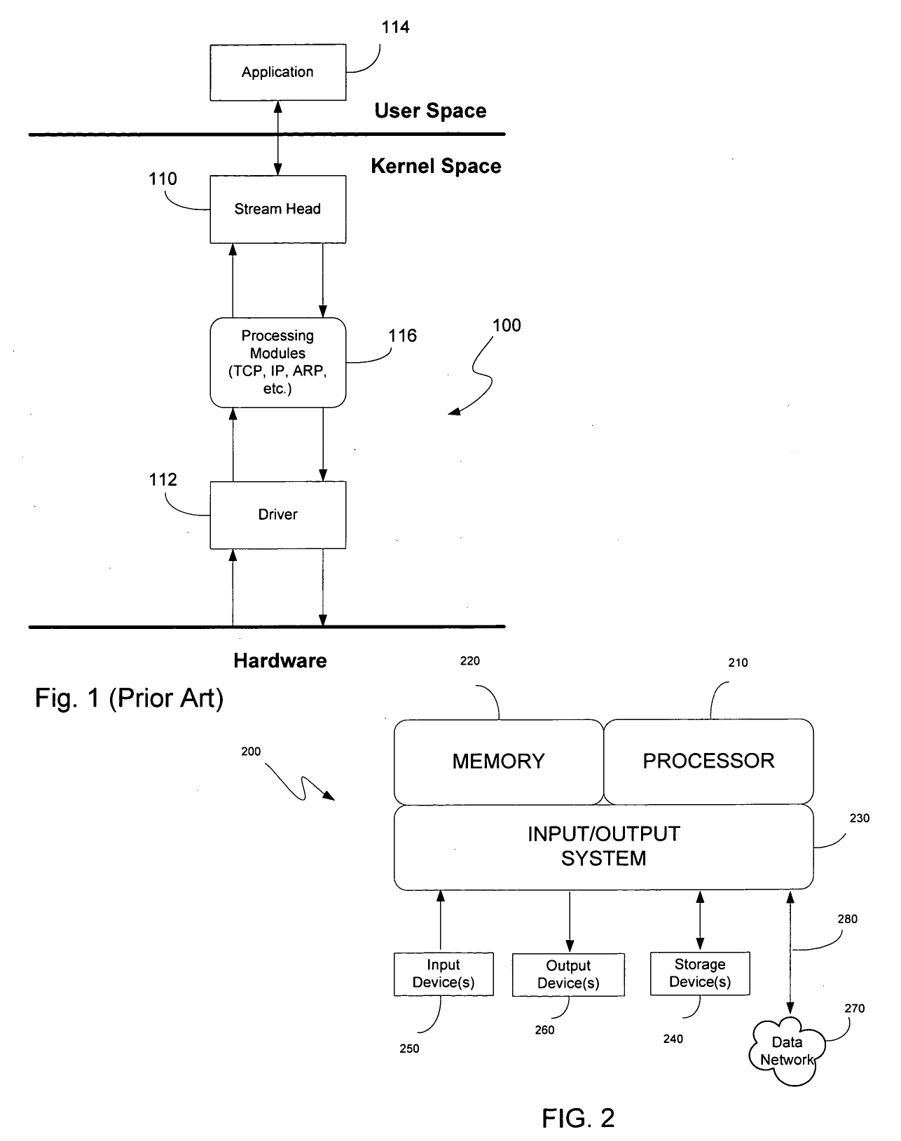

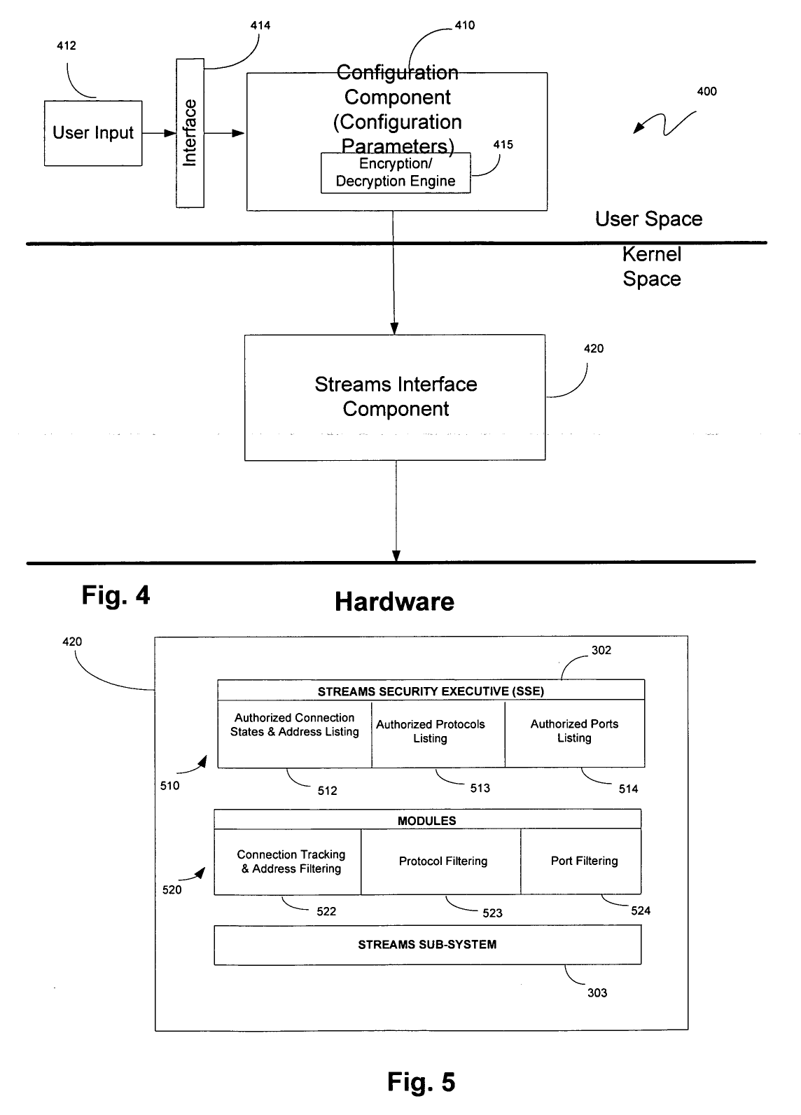

Having introduced the environment of the invention, reference is made to FIG. 4 which illustrates the principle components of a second exemplary embodiment of the STREAMS-based packet filtering system. While FIG. 2 above pertained to a host computer configurable to implement the functions of the invention to thus form one type of packet filtering system, FIG. 4 represents a packet filtering system 400 for use with such a host computer. Packet filtering system 400 broadly comprises a configuration component 410 and a STREAMS interface component 420. Among other things, STREAMS interface component 420 includes the STREAMS Security Executive (SSE) 302 represented in FIG. 3, and functions as a wrapper around an existing STREAMS sub-system 42, such as that represented in FIG. 1.

Configuration component 410 receives user input 412 via an appropriate user interface 414 and maintains a collection of configuration parameters based on the user input 412. This allows one to configure the proper settings for the firewall, as well as the security settings for the STREAMS sub-system itself. The user, likely an administrator, can interface with the system via command line or through a configuration console in the form of a graphical user interface (GUI). Accordingly, interface block 414 in FIG. 4 should be understood to encompass any of a variety of interfacing capabilities.

The collection of configuration parameters maintained by configuration component 402 preferably includes a set of authorized port designations, a set of authorized protocol designations and a set of authorized address designations. A set of authorized connection tracking states can also be maintained. In operation, configuration component 410 is loaded into memory by the SSE 302 when the machine is booted, with the last known-to-be-good configuration file being loaded. In a preferred embodiment, an encryption/decryption engine 415 is provided so that the collection of configuration parameters can be stored in a hard drive on the local machine as an encrypted configuration file when not needed, yet decrypted into a suitable format that is made available at the request of SSE 302 at runtime. Any of the various well-known encryption algorithms, such as DES, 3DES, Two Fish, Blowfish, or the like, may be used as part of encryption/decryption engine 415, such that no particular one is necessarily preferred.

While the firewall policies associated with configuration component 410 may be altered on-the-fly, the STREAMS sub-system security requires that the machine be rebooted. That is, the sub-system that actually controls the firewall and filtering mechanisms has its own security checks (applicable to the STREAMS sub-system). While the firewall and filtering modules can have their configurations altered on the fly (based on policies set by the STREAMS sub-system security), the actual STREAMS sub-system security configuration can not. In order for its configuration/policies to take effect, the machine must be rebooted.

The authorized “sets” or “listings” can be customized by the administrator. As its name implies, the set of authorized port designations identifies trusted source ports on the host computer for originating outbound network traffic and trusted listening ports on the computer for receiving inbound network traffic. The term “trusted ports”, as used in this context, does not necessarily implicate only the TCP and UDP ports in the 0 to 1023 range associated with UNIX systems (i.e. those which generally require super user privileges if a process is going to listen for incoming connections on trusted ports or originate connections to a remote server using one of these trusted ports as the source ports). Rather, for purposes herein, “trusted ports” or “authorized ports” simply refers to those pathways into or out of the computer or a network device which have been identified within the configuration component as being permissible for use. As such, the set of authorized port designations may or may not overlap with the numerical range of “trusted ports” conventionally associated with Unix systems.

In similar fashion, the set of authorized protocol designations relates to those communications protocols which are identified through the configuration component as trustworthy for purposes of inbound and outbound network traffic, while the authorized address designations identify trusted source and destination addresses for inbound and outbound network traffic. The connection tracking states refers to the ability to maintain sate information about a connection in memory tables, such as open sockets, protocol types, connection stats/states and timeouts. Connection tracking and address filtering can be implemented in the same module, while port filtering and protocol filtering are each done in a dedicated module. Of course, the modular implementation for accomplishing the various filtering options can be tailored accordingly. The various filtering information for the ports, protocols, addresses and states may be obtained from a configuration file at system boot.

It is contemplated that the various sets or listings of port, protocol and address designations can be identified through the configuration component 410 in a variety of manners. For example, there can be a listing of available to designations which, through a GUI, the administrator manually selects from to specifically identify those which are authorized for use. Alternatively, the administrator's selection from the listing could indicate those which are specifically not authorized for use. Appropriate rule sets could also be employed to effectuate the designations. Furthermore, the invention contemplates that the respective listings can be updated periodically as needed and through known means. Accordingly, these represent only some possible ways in which these designations can be made and maintained, and the present invention should not be unduly limited to any particular approach.

The STREAMS interface component 420 is diagrammatically represented in FIG. 5 to include the Stream's security executive (SSE) 302, a set of filtering modules 510, as well as the out-of-the box STREAMS sub-system 303. SSE 302 manages the firewalling and local security policies for sub-system 303. Among its various jobs, it interfaces directly with the configuration component 410 and also manages the various modules typically associated with a Stream's sub-system, including add-on packet filtering modules 520. SSE 302 is the main program that calls the other modules as function calls within the main program. SSE 302 distributes the appropriate policies to each of the firewalling modules 520 according to the set of configuration parameters, collectively 510, obtained from configuration component 410. These configuration parameters 510 preferably include a listing 512 pertaining to authorized connection states and addresses, a listing 513 pertaining to authorized protocols, and a listing 514 pertaining to authorized ports. SSE 302 communicates firewalling policies in accordance with these listings 512-514, respectively, to the various firewalling modules 522-524. Connection tracking and address filtering module 522 is a STREAMS based module that performs the functionality that its name implies. Based on its configuration, it will filter communications by the address of the sender and recipient of packets, as well to ensure that proper connection tracking states are adhered to. The connection tracking support may be added for more robust security and to help thwart many common types of network attacks. Protocol filtering module 524 stops all inbound and outbound communication that does not adhere to permitted protocols. It is also designed to detect any potential tunneling types of activity that may not be a recognized protocol. It can be configured to make sure that all traffic complies with proper RFCs for the respective protocols that are implemented. Port filtering module 526 simply ensures that only traffic allowed to pass in either direction is allowed by a specific port. Any traffic that comes in on a port that is not allowed is dropped.

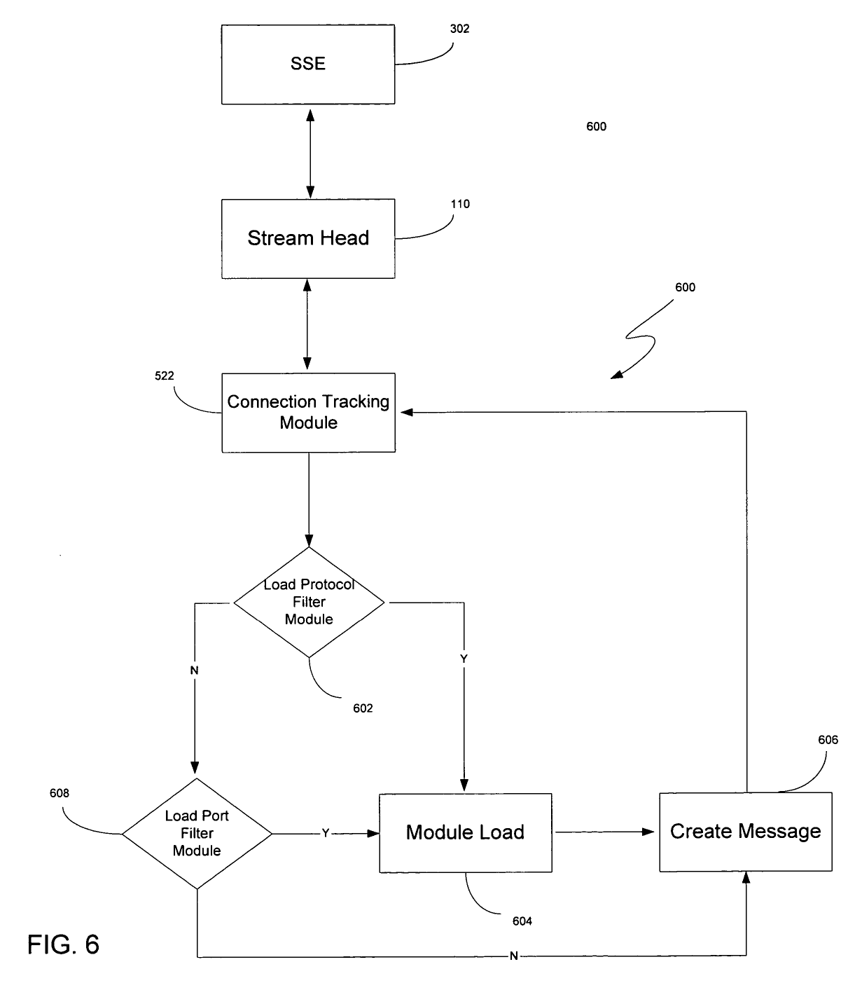

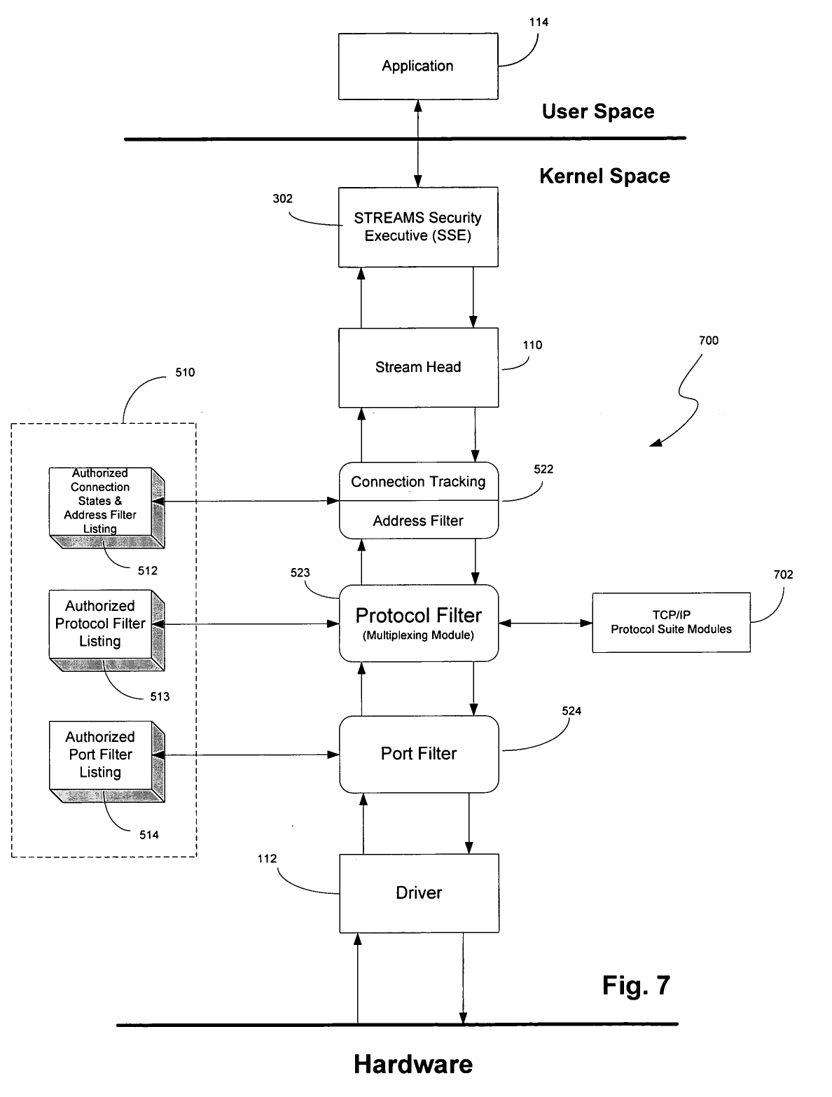

A representative initialization routine 600 for the packet filtering system of the invention is represented in the high level flowchart shown in FIG. 6. The presumption here is that the kernel loads the SSE 302, stream head (SH) 110, and the connection tracking module and address filtering module (CTM) 522 at boot time. This ability is “built-in” to the generic Solaris kernel during the network initialization phase of the system boot.

During the network initialization phase, and after SSE 302, SH 110 and CTM 522 are loaded, each packet filtering module goes through its own initialization described in FIG. 6. At boot time, SSE 302 takes control of the STREAMS sub-system 303 and creates an abstract of it for compatibility issues. Also at boot time, SSE 302 loads into memory the last known good configuration file which is decrypted. Based on the policies set forth in the configuration file, the appropriate firewalling modules are then loaded into the STREAMS sub-system and configured for operation.

More particularly, after the configuration file is read into the SSE, messages are created to pass down to the CTM via the read queue. All STREAMS modules have a read and a write queue (RQ/WQ), and information can be obtained by the various modules from these queues via their respective data structures queue_t. These messages will carry the configure information to the CTM for further configuration. The messages could be of type mblk_t, a message block data structure for Solaris. The messages arrive at the CTM 522 and are placed in a processing buffer. The module will block if too many messages are in the buffer. To prevent a deadlock, a timeout is placed on each module's read queue and if that timeout is met all messages in the RQ will be rejected and a corresponding message will be placed in the WQ and passed back to the caller.

Each configuration message is popped from the queue. The first message processed looks to see if the protocol filter should be loaded at 602. If so, the system call to load the module is called and passed the name of the module to load at 604. Upon either a success or failure, a message is created at 606 with the result and it is sent to the CTM 522. If, however the message is not for the protocol filter, it is passed to the port filter. If the port filter is to be loaded at 608, the system call for loading modules is called and the name of the module is passed for loading at 604. If not, then there must be a problem in the configuration—and to prevent any system locks, a simple error message is created at 606 and passed to CTM 522.

Upon successful initialization of the respective modules CTM 522 sends a message upstream to the SSE 302 informing it that initialization has completed and that the respective filter configuration can now be sent. SSE 302 begins to read the corresponding rules (i.e. the configuration parameters) from the configuration file. Examples of such rules might be similar to the following:

[DEFINE]
ANYHI:1025-663555
RESLO:0-1024
[PORT FILTER]
ENABLED=YES
FILTER=IN:80,OUT:ANYHI
[PROTOCOL FILTER]
ENABLED=YES
DENY=ALL
ALLOW=ARP,TCP,IP
[CONNECTION TRACKING]
ENABLED=TRUE
[IP FILTER]
ENABLED=TRUE
ORDER=ALLOW:DENY
DENY=10.1.1.:0.0.0.0:23.4.1.2
ALLOW=ALL

In this example above, which is for representative purposes only, the first section allows one to define all the macros to be used throughout the rest of the configuration file. Here a range of ports is defined. Next, is the section for the port filter. The instructions inform it to load the module with the “enabled” flag, and then proceed to configure the ports to filter. In this example, only packets destined for port 80 are allowed to enter, and any outgoing packets from a “hi” port are permitted to leave. The next section enables the protocol filter. It is preferred to initially deny everything for default security reasons. A specification can then be made as to those protocols which will be allowed to communicate with the machine.

In the above example connection tracking is turned on. Therefore, the module will now keep track of connection states through lists of valid tables in memory. The IP filtering is enabled, and an order is specified. This is important in that setting the order will make it easier to filter addresses. For example, in the configuration above, world access is allowed to the system with the exception of a select few addresses, or subnets, as specified by 10.1.1. As such, 10.1.1.1-10.1.1.255 will be rejected. If one were to set the order to deny:allow, access to the world would normally be denied with the exception of a small few allowed by specified addresses.

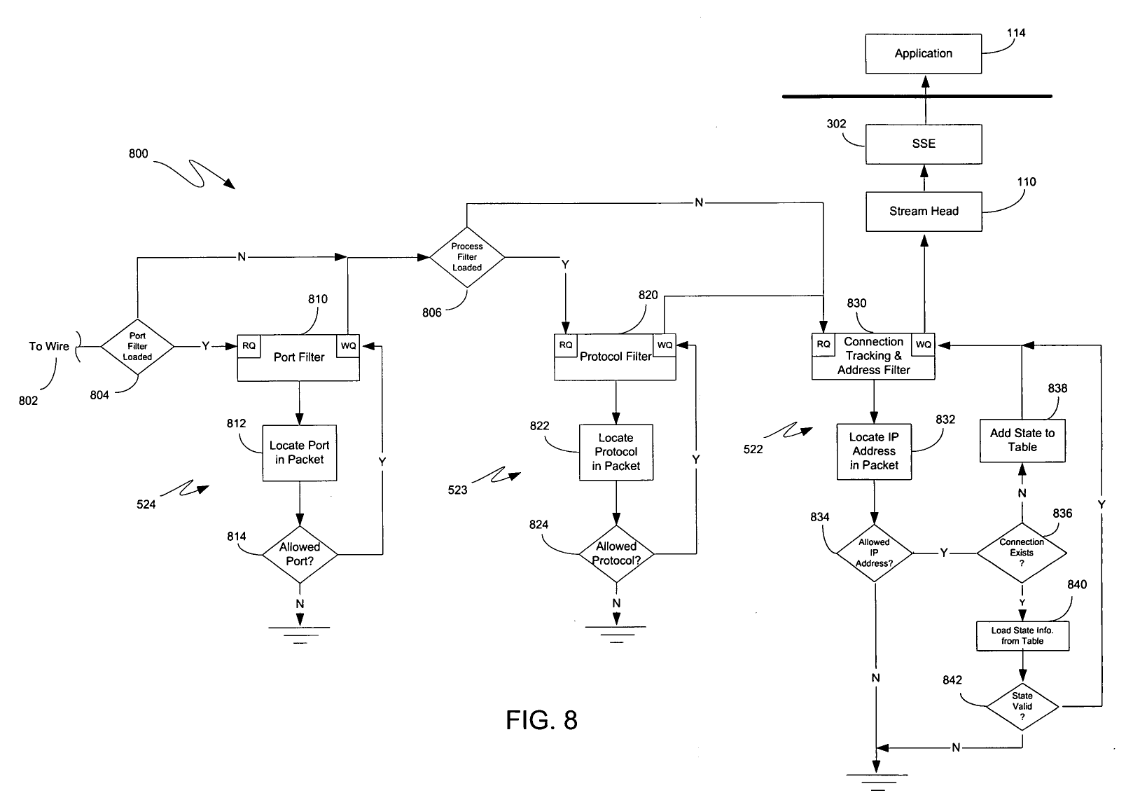

A representative TCP/IP implementation of the packet filtering system of the present invention may be appreciated with reference to both the stream's interface diagram 700 of FIG. 7 and the high level functional flow diagram 800 of FIG. 8. FIG. 8 depicts a flow diagram for upstream packet transmission so the description will proceed as if an inbound packet were destined for a user space application 114. It is to be appreciated, though, that a corresponding diagram similar to that shown in FIG. 8 would apply for downstream packet transmission, and thus need not be particularly described to be appreciated by the ordinarily skilled artisan. It is further assumed in FIGS. 7 and 8 that both the port filter module 524 and the protocol filer module 523 have been loaded so that each would be sequentially encountered by an inbound packet adhering to the user-defined configuration parameters. For purposes of clarity, though, the reader will note that FIG. 8 is diagramed to allow for situations where one or more of these filtering modules has not been loaded.

Accordingly, when an inbound packet arrives to the system from the wire 802 it encounters a driver 112, in this case a NIC driver, as known in the art. Assuming the port filter module 524 is loaded, such that inquiry 804 is in the affirmative, it will be preferably placed functionally at the lowest level allowing it to receive packets directly from the wire (NIC driver). The arriving message (everything is deemed a message, including packets) is placed in the read queue (RQ) for the port filter's queue structure 810 so that it may be processed according to an internal function. This internal function locates at 812 the port address within the message and verifies, based on the authorized port filter listing 514 that is part of the set of user-defined configuration parameters 510 maintained by SSE 302, whether the destination port is allowed. If the destination port is not allowed, then the packet is dropped in response to inquiry 814. If, however, the destination port is allowed, then the message is placed in the write queue (WQ) for port filter module 524 and transmitted upstream.

Assuming that the protocol filtering module 523 has been loaded, such that a response to inquiry 806 is in the affirmative, the message arrives at the queue structure 820 for the module, and more particularly at the read queue (RQ) thereof. At the protocol filter module, which is designed as the second level of defense after port filtering, the flow proceeds in a similar fashion. An internal function is invoked at 822 to locate the protocol field within the message and verify whether the protocol is allowed at 824 to be processed by the local machine. Operation 824 can really involve two levels of protection. A first level ensures that the protocol is an allowed protocol in the configuration file, as discussed above. An internal function can thus reference the authorized protocol listing 513. Based on a comparison, the packet is either dropped or allowed.

A second level of defense can then be invoked to additionally ensure that the packet's protocol is RFC compliant. Compliance of RFC protocols is done by validating the header information against a known set of rules specified by the RFC. This can usually be accomplished by validating header size, option boundaries, etc. The following pseudo-code provides a representative example of how this might work:

```
Struct tcphdr = incoming TCP header;
Does the “Data Offset” of tcphdr.offset point to data?
    If “no” reject packet
Does tcphdr.reserved field equal zero?
    If “no” reject packet
Which tcphdr.control bit is set?
    If “urgent pointer” is set, mark URG
Validate tcphdr.window size is no more then 1500
    If invalid reject packet
If URG is set, validate tcphdr.urgent fields contains pointer
information
    If invalid reject packet
Validate tcphdr.options against list of defined acceptable
options and specifications from RFC list.
    If any are invalid or should not be used, reject packet.
Does tcphdr.padding exist?
    Is it necessary?
        If “no” reject packet
```

Ultimately, if the packet's protocol is allowed at 824 in FIG. 8, it is processed by the TCP/IP protocol suite 702 since the inbound packet relates to a network communication. For this purpose, it should be noted that protocol filtering module 523 is preferably a multiplexing module. The packet is then placed in the WQ of queue structure 820 and sent upstream.

The inbound packet next encounters the queue structure 830 for the connection tracking and address filter module 524. When the message arrives at this RQ, an associated internal function locates, at 832, the IP address(es) for the packet and determines if it/they are allowed at 834. If not, the packet is dropped. If allowed, a determination is then made at 836 as to whether this inbound packet relates to a pre-established connection. If not, its state is added to the appropriate memory table at 838. In other words, necessary field data from the packet is added to the memory table, which can be a data structure in memory on the computer system. Such field data will likely include the source and destination address from the IP header, as well as source port, destination port, ACK number, sequence number, and desired reserved bit information (such as ACK, SYN and FIN) from the TCP header. Once the pertinent field data has been collected, the message then proceeds to the WQ for the module, and then to stream head 110. Stream head 110 then passes it to SSE 302 which, based on its set of configuration parameters 510, has already determined that the inbound packet meets the filtering criteria. Thus, SSE 302 passes the inbound packet to application 114 for further processing. Alternatively, if the packet does relate to an existing connection at 836, its state information is loaded from the table in memory at 840 and a determination is made at 842 if the state is valid. If valid, the message is transmitted to the module's WQ; otherwise, it is dropped.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A packet filtering system for use with a host computer that is configured with a UNIX System V OS implementing a STREAMS sub-system, said packet filtering system comprising:
(a) a configuration component for maintaining a collection of configuration parameters based on user input, said configuration parameters including:
(i) a set of authorized port designations identifying trusted source ports on the host computer for originating outbound network traffic and trusted listening ports on the host computer for receiving inbound network traffic;
(ii) a set of authorized protocol designations identifying trusted communications protocols for inbound and outbound network traffic, respectively; and
(iii) a set of authorized address designations identifying trusted source addresses for inbound network traffic and trusted destination addresses for outbound network traffic;
(b) a STREAMS interface component for managing bi-directional transmission of packets according to said collection of configuration parameters, said STREAMS interface component including:
(i) a port filtering module dynamically insertable into the stream between the stream head and the driver, said port filtering module operative to analyze inbound and outbound packets and to block transmission of packets which do not conform to said set of authorized port designations;
(ii) a protocol filtering module dynamically insertable into the stream, upstream of said port filtering module, said protocol filtering module operative to analyze inbound and outbound packets and to block transmission of packets which do not conform to said set of authorized protocol designations; and
(iii) an address filtering module dynamically insertable into the stream, upstream of said protocol filtering module, said address filtering module operative to analyze inbound and outbound packets and to block transmission of packets which do not conform to said set of authorized address designations,
whereby inbound and outbound packets which are not blocked by any of said filtering modules are, respectively, passed upstream and downstream between an associated network device and stream head.

2. A packet filtering system according to claim 1 comprising a user interface for inputting said collection of configuration parameters to said configuration component.

3. A packet filtering system according to claim 1 comprising an encryption engine for encrypting said collection of configuration parameters to generate enciphered configuration parameters, and a decryption engine for decrypting the enciphered configuration parameters whereby they are available to said configuration component at runtime.

4. A packet filtering system according to claim 1 wherein the Unix System V OS is Solaris.

5. A packet filtering system according to claim 1 wherein said collection of configuration parameters identifies a set of authorized modules for implementation within the STREAMS sub-system.

6. A packet filtering system according to claim 5 wherein each of said port filtering module, said protocol filtering module and said address filtering module is identified within said set of authorized modules.

7. A packet filtering system according to claim 5 wherein said STREAMS executive component is operative to monitor the collection of configuration parameters within said configuration component and to only permit an authorized module to be dynamically loaded into the Stream at runtime.

8. A packet filtering system for use with a host computer, wherein said host computer is configured with a UNIX System V OS implementing a STREAMS sub-system, said packet filtering system comprising:
(a) a storage device for storing a configuration file that includes a collection of inbound and outbound configuration parameters; and
(b) a processor programmed, with respect to inbound packets intended for transmission via the STREAMS sub-system from an associated network driver to an associated user process, to:
(i) pass each of said inbound packets to an upstream filter that is functionally interfaced between the associated network driver and the stream head, whereby said upstream filter permits upstream transmission to the stream head of inbound packets which conform to said inbound configuration parameters, while blocking upstream transmission to the stream head of inbound packets which fail to conform to said inbound configuration parameters;
said processor being further programmed, with respect to outbound packets intended for downstream transmission via the STREAMS sub-system from an associated user process to an associated network driver, to:
(ii) pass each of said outbound packets to a downstream filter that is functionally interfaced between the stream head and the network driver, whereby said downstream filter permits downstream transmission to the associated network driver of outbound packets which conform to said outbound configuration parameters, while blocking downstream transmission to the associated network driver of outbound packets which fail to conform to said outbound configuration parameters.

9. A computerized method of managing bi-directional transmission of packets within a protocol stack of a host computer, wherein said host computer is configured with a UNIX System V OS implementing a STREAMS sub-system that invokes a stream head for regulating data transfer between user processes and network drivers, said computerized method comprising:
with respect to inbound packets intended for upstream transmission, via the STREAMS sub-system, from an associated network driver to an associated user process:
passing each of said inbound packets to an upstream filter that is functionally interfaced between the associated network driver and the stream head, whereby said upstream filter permits upstream transmission to the stream head of inbound packets which conform to inbound configuration parameters, while blocking upstream transmission to the stream head of inbound packets which fail to conform to said inbound configuration parameters; and
with respect to outbound packets intended for downstream transmission, via the STREAMS sub-system, from an associated user process to an associated network driver:
passing each of said outbound packets to a downstream filter that is functionally interfaced between the stream head and the network driver, whereby said downstream filter permits downstream transmission to the associated network driver of outbound packets which conform to outbound configuration parameters, while blocking downstream transmission to the associated network driver of outbound packets which fail to conform to said outbound configuration parameters.

10. A computerized method according to claim 9 comprising pre-selecting said inbound and outbound configuration parameters through a user interface.

11. A computerized method according to claim 9 comprising identifying said inbound and outbound configuration parameters within a configuration file.

12. A computerized method according to claim 11 comprising identifying, within said configuration file, a set of authorized modules for implementation within the STREAMS sub-system.

13. A computerized method according to claim 12 comprising preventing any programming modules from being dynamically loaded into the STREAMS sub-system at runtime which are not identified within said configuration file as authorized modules.

14. A computerized method according to claim 11 comprising encrypting said configuration file to create an enciphered configuration file.

15. A computerized method according to claim 14 comprising storing the enciphered configuration file in non-volatile memory on the host computer.

16. A computerized method according to claim 14 comprising decrypting the enciphered configuration file so that said inbound and outbound configuration parameters are available to the STREAMS sub-system at runtime.

17. A computerized method according to claim 9 whereby said inbound and outbound configuration parameters include:
(a) a set of authorized port designations identifying trusted source ports on the host computer for originating outbound network traffic and trusted listening ports on the host computer for receiving inbound network traffic;
(b) a set of authorized protocol designations identifying trusted communications protocols for inbound and outbound network traffic, respectively; and
(c) a set of authorized address designations identifying trusted source addresses for inbound network traffic and trusted destination addresses for outbound network traffic.

18. A computerized method according to claim 17 comprising ensuring that each of the protocols within said set of authorized protocol designations is RFC compliant.

19. A computerized method according to claim 9 wherein the Unix System V OS is Solaris.

20. A computer-readable medium for use with a host computer, wherein said host computer is configured with a UNIX System V OS implementing a STREAMS sub-system that invokes a stream head for regulating data transfer between user processes and network drivers, said computer-readable medium having executable instructions for managing the transmission of packets within the STREAMS sub-system according to a method comprising:
with respect to inbound packets intended for upstream transmission, via the STREAMS sub-system, from an associated network driver to an associated user process:
passing each of said inbound packets to an upstream filter that is functionally interfaced between the associated network driver and the stream head, whereby said upstream filter permits upstream transmission to the stream head of inbound packets which conform to inbound configuration parameters, while blocking upstream transmission to the stream head of inbound packets which fail to conform to said inbound configuration parameters; and
with respect to outbound packets intended for downstream transmission, via the STREAMS sub-system, from an associated user process to an associated network driver:
passing each of said outbound packets to a downstream filter that is functionally interfaced between the stream head and the network driver, whereby said downstream filter permits downstream transmission to the associated network driver of outbound packets which conform to outbound configuration parameters, while blocking downstream transmission to the associated network driver of outbound packets which fail to conform to said outbound configuration parameters.

21. A computer-readable medium according to claim 20 wherein said method pre-selects said inbound and outbound configuration parameters through a user interface.

22. A computer-readable medium according to claim 20 wherein said method identifies said inbound and outbound configuration parameters within a configuration file.

23. A computer-readable medium according to claim 22 wherein said method identifies, within said configuration file, a set of authorized modules for implementation within the STREAMS sub-system.

24. A computer-readable medium according to claim 23 wherein said method prevents any programming modules from being dynamically loaded into the STREAMS sub-system at runtime which are not identified within said configuration file as authorized modules.

25. A computer-readable medium according to claim 22 wherein said method encrypts said configuration file to create an enciphered configuration file.

26. A computer-readable medium according to claim 25 wherein said method stores the enciphered configuration file in non-volatile memory on the host computer.

27. A computer-readable medium according to claim 25 wherein said method decrypts the enciphered configuration file so that said inbound and outbound configuration parameters are available to the STREAMS sub-system at runtime.

28. A computer-readable medium according to claim 20 wherein said inbound and outbound configuration parameters include:
(a) a set of authorized port designations identifying trusted source ports on the host computer for originating outbound network traffic and trusted listening ports on the host computer for receiving inbound network traffic;
(b) a set of authorized protocol designations identifying trusted communications protocols for inbound and outbound network traffic, respectively; and
(c) a set of authorized address designations identifying trusted source addresses for inbound network traffic and trusted destination addresses for outbound network traffic.

29. A computer-readable medium according to claim 28 wherein said method ensures that each of the protocols within said set of authorized protocol designations is RFC compliant.

30. A computer-readable medium according to claim 20 wherein the Unix System V OS is Solaris.
